(19) United States
(12) Patent Application Publication
(10) Pub. No.: US 2007/0241209 A1
(43) Pub. Date: Oct. 18, 2007

(54) Flow equalization baffle for multi-nozzle spray systems

(75) Inventors: James S. Calhoun, Corbin, KY (US); Mark A. Ferguson, Rockholds, KY (US)

Correspondence Address: Paul D. Greeley;OHLANDT, GREELEY, RUGGIERO & PERLE, L.L.P., 10th FLOOR, ONE LANDMARK SQUARE, STAMFORD, CT, 06901-2682, US

(73) Assignee: JACKSON, MSC., INC.

(21) Appl. No.: 11/818,718

(22) Filed: Jun. 15, 2007

Related U.S. Application Data
(62) Division of application No. 11/650,151, filed on Jan. 5, 2007.
(60) Provisional application No. 60/756,534, filed on Jan. 5, 2006.

(51) Int. Cl. B05B 1/34

(52) U.S. Cl. 239/464

(57) ABSTRACT

A method of equalization of fluid flow having a more balanced flow rate and spray pattern along a length of a fluid distribution arm comprising a plurality of apertures, the method comprising: partitioning a portion of an interior of the distribution arm into a first compartment and a second compartment, wherein the first compartment does not include any of the apertures; and passing fluid into the first compartment before entering the second compartment.

### CROSS-REFERENCED APPLICATIONS

The present disclosure is a divisional application of U.S. patent application Ser. No. 11/650,151, filed on Jan. 5, 2007, and claims priority to U.S. Provisional Patent Application No. 60/756,534, filed on Jan. 5, 2006, both of which are incorporated herein by reference in their entirety.

### BACKGROUND

1. Field

The present disclosure relates generally to multi-nozzle spray systems. In particular, the present disclosure is related to a flow equalization baffle for multi-nozzle spray systems used in, for example, dishwashing machines.

2. Description of the Related Art

Typical multi-nozzle spray systems may be utilized for distribution of fluid for purposes, such as, washing, rinsing, and fluid mixing or heat distribution. Each nozzle opening in a multi-nozzle spray system generally provides a spray pattern that is undesirably non-uniform in shape, size, pressure, and angle. Resistance of flow creates a majority of spray pattern non-uniformity. One example of a multi-nozzle spray system is a pumped spray system that has a closed terminal end and nozzle openings along a length of a tube. The pumped spray system will characteristically create a non-uniform spray pattern with maximum distortion of the spray pattern being at the nozzle opening closest to an outlet of the tube and minimum distortion at the nozzle opening closest to the terminal end. The distorted spray patterns are angled in a direction toward a direction of fluid flow through the tube. In particular, an angle of fluid emitted from each nozzle opening increases toward the terminal end. This effect is especially pronounced when a cut opening is utilized as the nozzle openings with an area of the cut opening being directly proportional to the degree of distortion of the spray pattern. Such non-uniform spray patterns, for example, in dishwashing machines with rinse arms yield less consistent cleaning results than an even distribution of wash water and soap across ware, and in particular, even heat distribution across all ware. Such even distribution of wash water, soap, and heat across ware is critical to proper sanitation requirements of commercial dishwashing machines. In addition, rinse arms will achieve greater efficiency in removal of residue detergent use in cleaning processes with even distribution of wash water and soap across ware, and in particular, even distribution of heat across all ware.

Partitions that are planer or tubular that have “cutouts” or holes or notches along a length of the partition have been inserted in multi-nozzle spray systems in an attempt to equalize or direct spray patterns of nozzle openings. The partitions may create two or more distinct sections within a tube of the multi-nozzle spray system, such as, for example, by extending substantially an entire length of an interior of the tube. Thus, directing the flow of fluid transversely through the cutouts. These cutouts become easily clogged, such as, for example, with food materials. Thus, the multi-spray nozzle system must be frequently and extensive cleaned and the partition must be removable. Moreover, partitions have been used that require operating devices such as valves, gates, and analogous operating devices.

Plenums have also been utilized to direct and equalize fluid flow in a multi-nozzle spray system. Plenums generally reduce cross-sectional areas along the length of a tube. Plenums undesirably require tubes having specific shapes, e.g., tapered shapes that are not easily manufactured.

Accordingly, there is a need for an improved device that provides equalization of flow to achieve a more balanced flow rate and spray pattern along a length of a tube of a multi-nozzle spray system and does not require cutouts, operating devices, two or more distinct sections, transverse flow, or plenums.

### SUMMARY

A baffle which includes a projection portion which is sized to extend a certain length (L) into a tube of a multi-nozzle spray system. The projection portion has a width substantially equal to a width of the tube. A connector portion is connectable to the multi-nozzle spray system to cover a portion of an outlet of a tube in the multi-nozzle spray system.

A nozzle spray assembly which comprises: a spray arm assembly which comprises at least one outlet disposed therein to allow fluid to exit the spray arm assembly; a fluid distribution arm extending from the outlet of the spray arm assembly, wherein the distribution arm comprises an interior surface and a plurality of apertures disposed within the interior surface; and a baffle comprising: (i) a projection portion which extends within the fluid distribution arm a predetermined length, such predetermined length being less than the length of the distribution arm, and the projection portion having a width substantially similar to the cross-section of the interior surface of the distribution arm, thereby forming at least two compartments within the distribution arm wherein a first compartment is formed between a first portion of the interior surface of the distribution arm and a first side of the projection portion without any the apertures disposed within the first compartment, and a second compartment formed between a second portion of the interior surface of the distribution arm and a second side of the projection portion having at least a portion of the apertures disposed within the second compartment; and (ii) a connector portion disposed at an end of the projection portion which is in contact with the outlet of the fluid distribution arm, wherein the connector portion covers at least a portion of the outlet, whereby fluid exiting the outlet into the fluid distribution arm initially enters the first compartment of the fluid distribution arm before entering the second compartment.

Preferably, the projection portion has a length of about one half of the length of the distribution arm. The fluid after passing through the first compartment of the distribution arm enters both the second compartment of the distribution arm and that portion of the distribution arm without any portion of the projection compartment disposed therein.

The projection portion is planar. In addition, it is preferable that the projection portion be free of openings, thereby substantially prevent fluid from entering the second compartment without first passing entirely through the first compartment. The projection portion is disposed substantially perpendicular to the connector portion.

The connector portion is integrally connected to the projection portion. The connector portion and the projection portion are formed of materials which are substantially resistant to chemical detergents. The connector portion is affixed to the outlet of the spray arm assembly.

Preferably, the distribution arm is affixed to the spray arm assembly such that the outlet of the spray arm assembly is disposed covered by one end of the distribution arm.

The baffle creates angles of fluid flow exiting the apertures that are substantially symmetrical from a midpoint of the distribution arm outward. Preferably, the baffle equalizes flow at each of the apertures.

The distribution arm has a cut pattern that is substantially the same at a location of each of the apertures.

A method of equalization of fluid flow having a more balanced flow rate and spray pattern along a length of a fluid distribution arm comprising a plurality of apertures, the method comprising: partitioning a portion of an interior of the distribution arm into a first compartment and a second compartment, wherein the first compartment does not include any of the apertures; and passing fluid into the first compartment before entering the second compartment.

The projection portion may be sized to have a length (L) that preferably extends into a tube a distance of less than the entire length of the tube itself. More preferably, the projection portion of the baffle extends into the tube only about one half of the length of the tube. The projection portion may be planar. The projection portion may be free of openings. The projection portion may be substantially perpendicular to the connector portion. The connector portion may be integrally connected to the projection portion. The connector portion and the projection portion may be materials that are resistant to chemical detergents.

The above-described and other features and advantages of the present disclosure will be appreciated and understood by those skilled in the art from the following detailed description and drawings.

### BRIEF DESCRIPTION OF THE DRAWINGS

FIG. 1 is a side perspective view of a baffle according to the present disclosure;

FIG. 2 is a isometric view of the baffle of the present disclosure;

FIG. 3 is a sectional view of the spray arm assembly having a spray arm with the baffle; and

FIG. 4 is a side cross-sectional view of the spray arm assembly having the spray arm with the baffle and indicating flow path of fluid and a top view of the sectional view of the spray arm.

### DETAILED DESCRIPTION OF THE PREFERRED EMBODIMENT

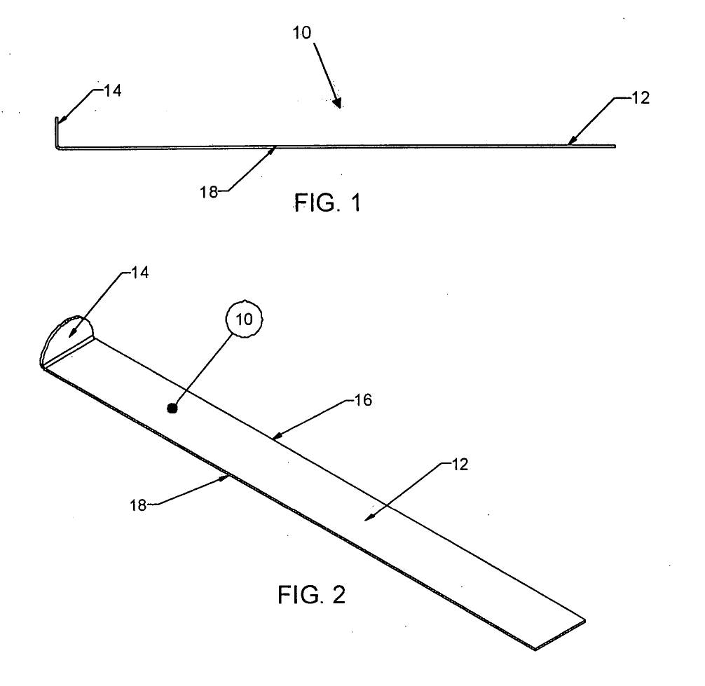

Referring now to FIGS. 1 through 4, an exemplary embodiment of a flow equalization baffle generally referred to by reference numeral 10 is illustrated. It has been determined by the present disclosure that baffle 10 provides equalization of flow to achieve a more balanced flow rate and spray pattern along a length of a tube of a multi-nozzle spray system.

Baffle 10 has a projection portion 12 and a connector portion 14. The particular shape of projection portion 12 can vary according to the particular needs of baffle 10. Projection portion 12 is sized to extend a length into a tube of a multi-nozzle spray system. Projection portion 12 may be sized to have a length that extends into about one half of the distance of a tube of a multi-nozzle spray system. Projection portion 12 has side portions 16 and 18 that are sized and shaped to fit flush with an interior wall of the tube when inserted. Projection portion 12, preferably, is planar with a width substantially equal to or slightly less than a width or diameter of the tube to be flush with an interior wall of the tube when inserted therein.

Projection portion 12 is connected to connector portion 14. Projection portion 12 may be substantially perpendicular to connector portion 14. Connector portion 14 may be integrally connected to projection portion 12 or connector portion 14 and projection portion 12 may be affixed via, such as, for example, screws, clamps, and the like. The particular shape of connector portion 14 that is utilized can vary according to the particular needs of baffle 10. Preferably, connector portion 14 is adapted to connect to a multi-nozzle spray system, such as, for example, an outlet end or an interior wall of a tube. Connector portion 14 may be affixed to the multi-nozzle spray system by screws, clamps, welding, and the like. Connector portion 14 may be sized to cover a portion of an outlet of a tube in a multi-nozzle spray system.

The particular type, including materials, dimensions and shape, of projection portion 12 and connector portion 14 that are utilized can vary according to the particular needs of baffle 10. Projection portion 12 and connector portion 14, preferably, are materials that are resistant to chemical detergents and corrosion, such as, for example, stainless steel and plastic. Preferably, projection portion 12 and connector portion 14 are stainless steel, and more preferably, stainless steel that is bent to form projection portion 12 and connector portion 14.

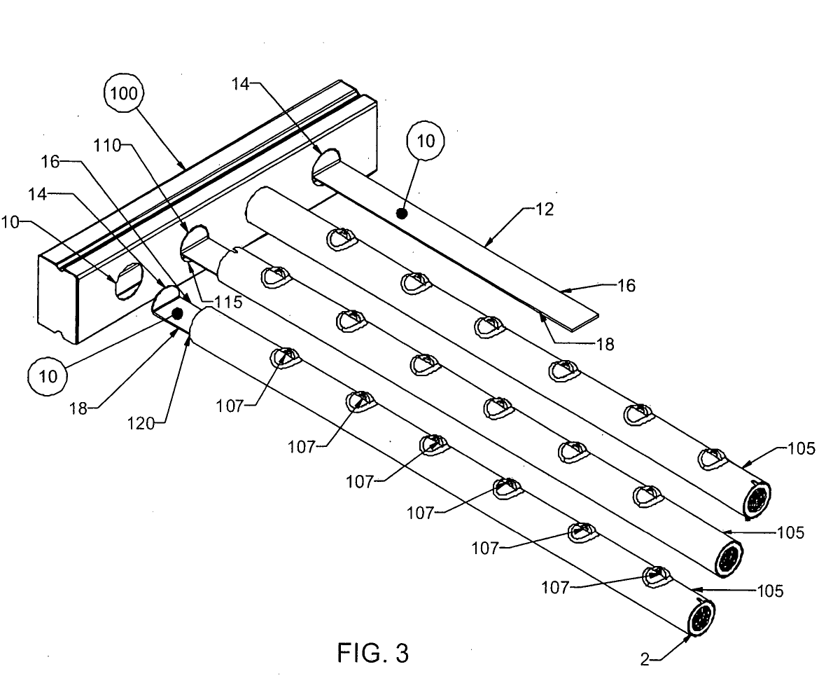

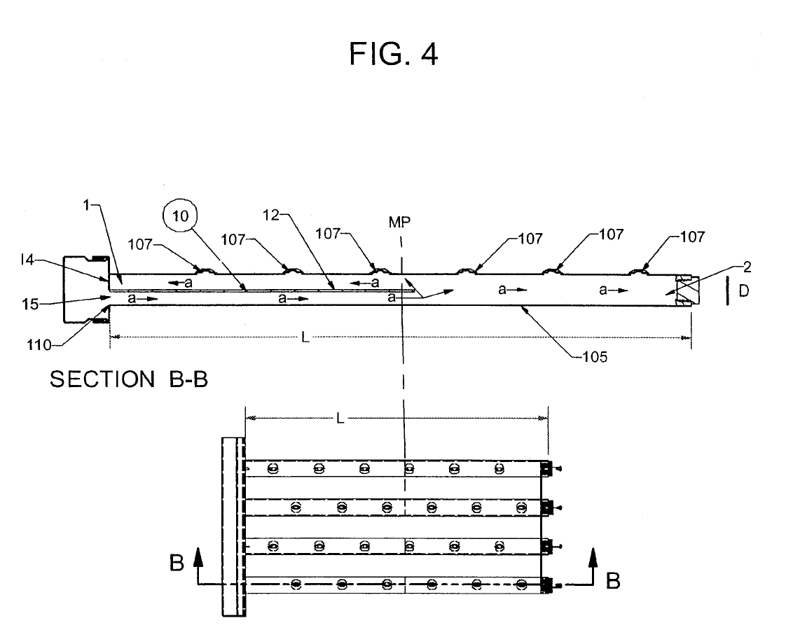

Referring to FIGS. 3 through 4, baffle 10 may be installed in a wash arm and/or rinse arm 105. Arm 105 has one or more apertures 107 of a spray arm assembly 100. Without wishing to be bound by any particular theory, it is believed the addition of baffle 10 into spray arm assembly 100 achieves a uniform spray pattern. Preferably, baffle 10 is positioned with projection portion 12 extending about one half of a length L of arm 105. The position of projection portion 12 may vary to any position along length L to achieve a “balanced” or symmetrical spray pattern. While in place within arm 105, side portions 16 and 18, preferably, are flush with an interior wall 120 of arm 105. Projection portion 12, preferably, is planar and has a width substantially equal to or slightly less than a diameter D of arm 105 and flush with interior wall 120. Arm 105 may be cylindrical or any other shape.

Connector portion 14 may connect to spray arm assembly 100 so that an outlet 110 has a portion that is blocked or restricted. Preferably, an open area 115 of outlet 110 that is not covered by connector portion 14 does not fall below a total area of the combined apertures 107 in each individual spray arm. Baffle 10, preferably, is free “cutouts,” openings, or notches. These “cutouts” can become easily clogged with food materials and require extensive cleaning. Baffle 10 may be permanently affixed to spray arm assembly 100. Moreover, no transverse flow is required. However, baffle 10 may have one or more cutouts and have transverse flow.

Baffle 10, by extending only for a portion of length L, creates a continuous, unrestricted, single flow path, as indicated by arrows a in FIG. 4, in which fluid, such as, for example, water, bypasses a first portion of arm 105. Arrows a show flow of fluid entering through open area 115 into a portion of arm 105 between baffle 10 and interior wall 120 partitioned from one or more apertures 107. Flow of fluid may continue to flow the length of baffle 10 bypassing the first portion of arm 105. Fluid may flow around baffle 10 exiting through one or more apertures 107 or beyond baffle 10 exiting through one or more aperture 107, as shown by arrows a. Thus, baffle 10 effectively creates two termination ends 1 and 2 within arm 105 that have similar or substantially equal spray pattern characteristics at each end 1 and 2 and provides a more uniform spray pattern along length L.

Angles of flow exiting one or more apertures 107 are substantially symmetrical from a midpoint MP of arm 105 outward to effectively create similar “angles of attack” or substantially equal angles of fluid flow, without a need for equalization of pressure or transverse flow. Therefore, arm 105 may have a cut pattern that is substantially the same at a location of each of one or more apertures 107, as shown in FIG. 3 and 4. The cut pattern that is substantially the same at a location of each of one or more apertures 107 eliminates a difference of cut angle and/or cut geometry that is a particular benefit for fabrication processes. Baffle 10 aids in the equalization of flow at each of one or more apertures 107 to achieve a more balanced flow rate and spray pattern along length L. Tests of baffle 10 show improved results of spray arms designs including baffle 10 over the prior art. Baffle 10 may be used in combination with transverse flow and equalization of pressure.

Baffle 10 may be used in any multi-nozzle spray system, such as, for example, commercial ware-washers and paint spraying applications. Baffle 10 may be used in applications having any pressure.

While the instant disclosure has been described with reference to one or more exemplary embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this invention.

What is claimed is:

1. A method of equalization of fluid flow having a more balanced flow rate and spray pattern along a length of a fluid distribution arm comprising a plurality of apertures, said method comprising:
partitioning a portion of an interior of said distribution arm into a first compartment and a second compartment, wherein said first compartment does not include any of said apertures; and
passing fluid into said first compartment before entering said second compartment.

2. The method according to claim 1, wherein said fluid distribution arm comprises a plurality of apertures disposed within said interior surface; and a baffle comprising: (i) a projection portion which extends within said fluid distribution arm a predetermined length, such predetermined length being less than the length of said distribution arm, and said projection portion having a width substantially similar to the cross-section of said interior surface of said distribution arm, wherein said first compartment is formed between a first portion of said interior surface of said distribution arm and a first side of said projection portion without any said apertures disposed within said first compartment, and said second compartment is formed between a second portion of said interior surface of said distribution arm and a second side of said projection portion having at least a portion of said apertures disposed within said second compartment; and (ii) a connector portion disposed at an end of said projection portion which is in contact with said outlet of said fluid distribution arm, wherein said connector portion covers at least a portion of said outlet, whereby fluid exiting said outlet into said fluid distribution arm initially enters said first compartment of said fluid distribution arm before entering said second compartment.

3. The method according to claim 2, wherein said projection portion has a length of about one half of the length of said distribution arm.

4. The method according to claim 3, wherein said fluid after passing through said first compartment of said distribution arm enters both said second compartment of said distribution arm and that portion of said distribution arm without any portion of said projection compartment disposed therein.

5. The method according to claim 2, wherein said projection portion is planar.

6. The method according to claim 2, wherein said projection portion is free of openings, thereby substantially prevent fluid from entering said second compartment without first passing entirely through said first compartment.

7. The method according to claim 2, wherein said projection portion is disposed substantially perpendicular to said connector portion.

8. The method according to claim 2, wherein said connector portion is integrally connected to said projection portion.

9. The method according to claim 2, wherein said connector portion and said projection portion are formed of materials which are substantially resistant to chemical detergents.

10. The method according to claim 2, wherein said distribution arm has a cut pattern that is substantially the same at a location of each of said apertures.
